(19) United States
(12) Patent Application Publication
(10) Pub. No.: US 2004/0122625 A1
(43) Pub. Date: Jun. 24, 2004

(54) Apparatus and method for predicting total ownership cost

(76) Inventors: Loren A. Nasser, Brentwood, TN (US); Animesh Dey, Brentwood, TN (US); Robert G. Tryon III, Brentwood, TN (US)

Correspondence Address: MORGAN, LEWIS & BOCKIUS, LLP., 3300 HILLVIEW AVENUE, PALO ALTO, CA, 94304, US

(21) Appl. No.: 10/636,887

(22) Filed: Aug. 7, 2003

Related U.S. Application Data
(60) Provisional application No. 60/401,892, filed on Aug. 7, 2002.

(51) Int. Cl. G06F 11/30

(52) U.S. Cl. 702/185

(57) ABSTRACT

An initial and maintenance cost of each component as well as a period over which to determine a total ownership cost is received. It is then ascertained whether each failed component should be repaired or replaced, and whether any component related to a failed component should be maintained. A supplier and associated initial cost is then selected for each component. The failure of each component over the period is predicted. A total ownership cost of the system is then determined by summing each component's initial cost and the maintenance cost of each failed component. The method may then repeat itself for a different supplier and associated different initial cost, until the total ownership cost is the same as or less than a target total ownership cost. The total ownership cost or a list of preferred suppliers and their associated components may then be displayed to the user.

This application claims priority to U.S. provisional patent application No. 60/401,892 filed Aug. 7, 2002. U.S. patent application Ser. No.'s 10/002,316 and 10/043,712 are both incorporated by reference herein in their entirety.

### BACKGROUND OF THE INVENTION

1. Field of the Invention

Generally, the present invention relates to an apparatus and method for predicting warranty and total ownership cost of a product or system. More particularly, probabilistic analysis models are used to address effects such as component variability, cost variability, reliability, or the like on total ownership cost (TOC) of a product or system.

2. Description of Related Art

Typically, during the initial stages of product development a manufacturer's primary focus is on meeting performance specifications and “launch cost” objectives. A product launch is often considered a success when production costs are less than estimated manufacturing target costs. However, simply because a product launch is successful, under these terms, does not dictate that the product will continue to be successful and profitable over a given product lifecycle.

Instead, the long term success of a product depends substantially on the reliability of the product over the given lifecycle, especially where the product is under warranty for a portion of the product's lifecycle. It is generally accepted in the manufacturing community that determining the true success of a product is both a function of meeting launch costs and product reliability performance. Indeed, it is widely recognized that reliability problems encountered during any manufacturer warranty period can severely reduce the profit margin for the product. For example, within the US automotive market sector, on average, General Motors (GM) handles nearly 22.5 million warranty claims per year in North America alone, spending roughly $3.5 billion a year servicing their warranty obligations. (Wall Street Journal, Apr. 8, 1999, White, G.).

A typical product lifecycle has four overall periods: 1) research and development (R&D); 2) design and concept demonstration; 3) full-scale development; and 4) production, operations, and maintenance (O&M). It has been shown that decisions made at the earliest stages of the product development cycle have the greatest impact on TOC of the finished product. As shown in FIG. 1, engineering decisions made during the design and concept demonstration period accounts for about 90 percent of the final product costs, even though only a small portion of the project budget has been expended by this time.

A drawback of the traditional method of designing and developing products to satisfy launch cost objectives is that by focusing primarily on launch costs the manufacturer often fails to consider the overall success of a product over its entire lifecycle. Therefore, many projects that are initially a ‘success’ for satisfying launch costs are not ultimately successful when the relative unreliability of the product, not considered fully during development of the product, reduces its long term profitability. Consequentially, TOC, defined as the combination of launch costs and replacement, repair, or warranty costs, would be a better metric for the focus of product design efforts.

Currently, total ownership costs and/or reliability considerations are not taken into account as traditionally there has been no efficient and/or economical way of performing cost analysis studies on a product's reliability or total ownership cost. Typically, the bulk of product reliability information needed to design to TOC is acquired during the later stages of the product development cycle. Although prototype testing does provide a limited amount of reliability information, often a statistically insignificant amount of prototype testing is undertaken. Furthermore, prototype testing often occurs late in the product lifecycle, after most of the budgeted expenses have been expended. Thus, a change in product design at such a late stage would severely increase a product's budget. Additionally, studying the multitude of possible product element combinations, such that the most profitable long term product can be determined, is too time consuming and costly. Therefore, since designers typically do not have a comprehensive amount of reliability or warranty cost data, nor the capability, time, or budget to predict it, designs are commonly not based on product TOC.

Accordingly, a method and apparatus for determining a product's or system's TOC at an early stage in the product lifecycle would be highly desirable.

### BRIEF SUMMARY OF THE INVENTION

According to the invention there is provided a method for determining a total ownership cost of a product or system. Initially, data for each component of a system is received by a product development engine. The data preferably includes cost data, reliability data, component data, and supplier data. The cost data preferably includes an initial cost of each component and a maintenance cost of each component. The reliability data preferably includes a lifecycle or period over which to determine a total ownership cost, an analytical interval, design parameters, and/or failure statistics for each component. The supplier data preferably includes a list of suppliers for each component and each supplier's associated initial cost for each component. Component data preferably includes any interrelationship between components, whether a component should be repaired or replaced, base materials, fracture strength, material quality, defect data, tolerance considerations, etc.

In a preferred embodiment, it is then ascertained whether each failed component should be repaired or replaced, and whether any component related to a failed component should also be maintained. A supplier and associated initial cost is then selected, either manually or automatically, for each component.

Reliability procedures in the product development engine then predict the failure of each component over the period. This prediction may be repeated to increase the accuracy of the prediction results. Also, the prediction may occur for one component at a time, or for all components simultaneously. In a preferred embodiment, the failure prediction is made using standard industry reliability analysis techniques, such as, for example, a Monte Carlo simulation.

A total ownership cost of the system is then determined by summing each component's initial cost and the maintenance cost of each failed component. The method may then repeat itself for different suppliers and their different associated initial cost, until the total ownership cost is the same as or less than a target total ownership cost. In another embodiment, the method repeats itself and alters component manufacturing parameters affecting component function, failure, reliability, and/or cost, until the total ownership cost for the system is the same as or less than a target total ownership cost. The total ownership cost may then be displayed to the user. Alternatively, a list of preferred suppliers and their associated components may be displayed to the user.

According to another embodiment, the present invention includes an apparatus for determining total ownership cost of a system. The apparatus generally includes a central processing unit for processing instructions in the memory. A communication interface is also provided for user interaction such as receiving input data and generating output from the apparatus. A memory is included for communicating through the communication interface, where communication can include receiving data such as data for each component of a system, including an initial cost of each component, and a maintenance cost of each component. Furthermore, a user may specify a period over which to determine a total ownership cost. Total ownership cost results can also be communicated through the communication procedures of the memory. The memory also predicts failures and reliability of each component of the system over the period through reliability procedures stored in the memory and includes procedures for determining a total ownership cost of the system by summing each component's initial cost and the maintenance cost of each failed component.

The memory also determines if each component should be repaired or replaced and whether any component related to a failed component should be repaired or replaced together with the failed component. The memory also selects different suppliers of components and the initial cost of each different component, then repeats the determination of total ownership cost. After determining the total ownership cost, the memory compares the determined total ownership cost with a target total ownership cost. If the total ownership cost is greater-than the target total ownership cost, the memory has procedures for repeating the determination of total ownership cost with a different component or different set of components. Furthermore, in one embodiment the different component may be a component manufactured to different parameters affecting the total ownership cost of the system.

In this way, the maintenance costs of the product or system are taken into account at an early stage in a product's or system's development. Therefore, suppliers and components can be selected based not only on the initial cost of the component, but also the cost of maintaining the product or system over its warranty period.

### BRIEF DESCRIPTION OF THE DRAWINGS

For a better understanding of the nature and objects of the present invention, reference should be made to the following detailed description, taken in conjunction with the accompanying drawings, in which:

FIG. 1 is a graph of typical determined cost and expended cost over development time according to a typical product development cycle;

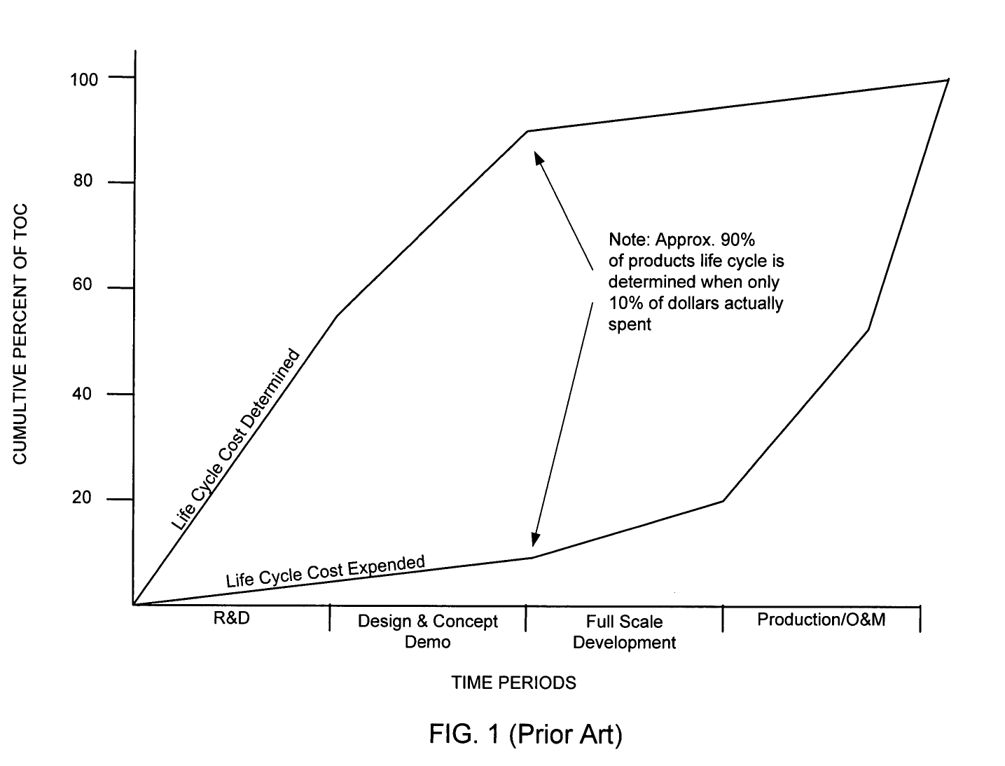

FIG. 2 is a block diagram of a product development engine according to an embodiment of the present invention;

FIG. 3A is a flow chart of a method for determining a total ownership cost of a system, according to an embodiment of the present invention;

FIG. 3B is a flowchart of the analysis step of FIG. 3A;

FIG. 3C is a flowchart of the determination of reliability step of FIG. 3B; and

FIG. 3D is a flowchart of the determination of the maintenance cost step of FIG. 3B.

Like reference numerals refer to corresponding parts, where applicable, throughout the several views of the drawings.

### DETAILED DESCRIPTION OF THE INVENTION

The present invention provides a method and apparatus for predicting reliability, reliability cost, and/or total ownership cost (TOC) for a given system or product. A system or product contains multiple components, such as an automobile having tires, windscreen, headlights, etc. A system contains multiple products, such as a fleet of an automobiles. However, it should be appreciated that the terms product and system may be used interchangeably. For example, although an automobile is described above as a system, the automobile may also be described as many systems containing multiple subsystems, such as air-conditioning units, an engine, etc. It should be appreciated that although the steps of the method are described below as occurring in series, many steps may occur in parallel, e.g., all components may be analyzed simultaneously.

The present invention uses probabilistic analysis models to predict component reliability and failure. This component reliability and failure together with the maintenance costs associated with each component is then used to determine TOC of the system over a predetermined period.

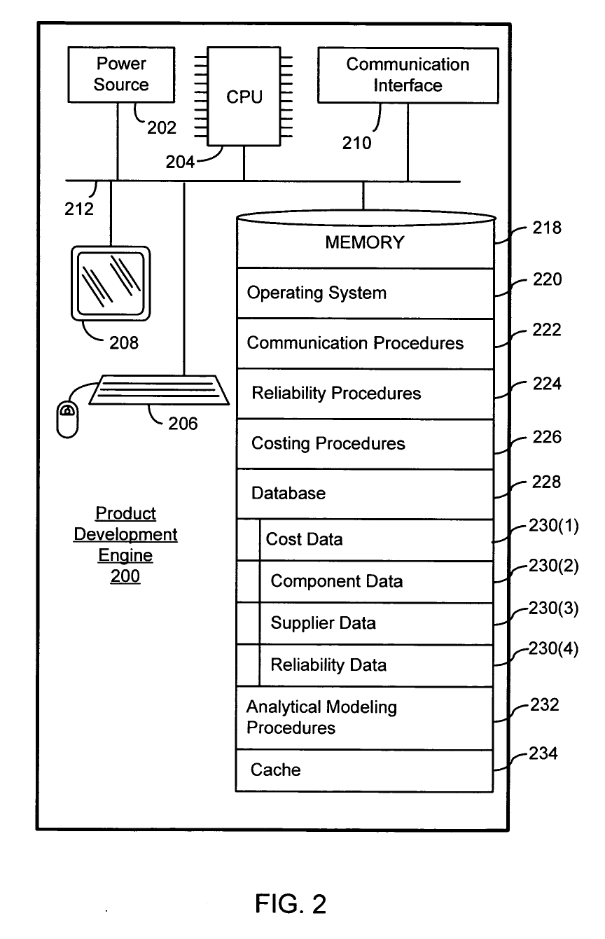

FIG. 2 is a block diagram of a product development engine 200 for predicting TOC, according to an embodiment of the present invention. It should be appreciated by one of ordinary skill in the art that all the elements of the product development engine 200, described below, need not be incorporated into all embodiments of the invention and are merely exemplary.

The product development engine 200 includes at least one central processing unit (CPU) 204; a memory 218; a communication interface 210; a power source 202; user interface devices, such as a monitor 208 and keyboard and mouse 206; and at least one bus 212 that interconnects these components

The memory 218 preferably includes high-speed random access memory and may include non-volatile memory, such as one or more magnetic disk storage devices. The memory 218 preferably stores an operating system 220, such as LINUX, UNIX or WINDOWS, that includes procedures for handling basic system services and for performing hardware dependent tasks. The memory 218 also preferably stores communication procedures 222 used for communicating with other computing devices and/or a user of the product development engine 200.

The memory 218 also preferably includes: reliability procedures 224, such as probabilistic analysis models, for determining the reliability of components, products, and/or systems; costing procedures 226 for performing maintenance cost functions on components, products, and/or systems; a database 228 for storing cost data 230(1), component data 230(2), supplier data 230(3), and reliability data 230(4). Further included are analytical modeling procedures 232 and a cache 234 for temporarily storing data.

The component data 230(2) is provided per component, and preferably includes: a repair/replace flag; the hierarchy of the components within the system; and the interrelationship between components within the system. The repair/replace flag indicates whether the component should be repaired or replaced when the component fails, and is generally determined by the manufacturer of the component. Alternatively, this flag may be determined based on the initial cost of the component (described below) versus the repair cost of the component, i.e., whether it is less expensive to repair or replace the component. The hierarchy of the component is the predefined position of the component in the product or system being analyzed. As an example of such a hierarchy, consider a vehicle engine cooling system at a second tier. The following third tier components 1) thermostat, 2) hose, 3) radiator cap, 4) water pump seal, and 5) hose clamp form part of an engine cooling system, which in turn forms part of a first tier vehicle system. Furthermore, design parameters are used by the analytical modeling procedures 232 to determine failure, reliability, and failure statistics. Although not shown in FIG. 2, other forms of data that may also be useful in generating product predictions include manufacturing plans, product strategy, and the like. Furthermore, data such as lifecycle of the system, a sampling rate or analysis interval, and a confidence level, (all of which are components of the reliability data and further described below) are predetermined by a designer and entered as data into the product development engine 200. Alternately, component data 230(2) can include design parameters for a component such as component tolerances, component reliability, component strength, component failure rate, component cost, component base material, and the like.

The interrelationship between components describes the maintenance relationship of a component with other components within the larger system. As many components of a product or system work in conjunction with one another in the product or system, some components may be grouped together for maintenance. For example, when the hose (component 2) or the hose clamp (component 5) fails, both of these components must be repaired or replaced together.

The supplier data 230(3) preferably includes a list of suppliers that provide each component of the product or system and an initial cost for each component by each supplier. For example, companies A, B, and C may supply the thermostat; company B may supply the radiator cap; and the hose may be self-manufactured. Furthermore, the thermostat supplied by company A may have an initial cost different from that of the thermostat sold by company B. Supplier data 230(3) may also consider the location of the supplier, whether the supplier is capable of making the component to a manufacturers specification, past history of a specific supplier, or the like.

The reliability data 230(4) is provided per component, and preferably includes the historical reliability of the component; the failure statistics for that component; a period or lifecycle over which to determine total ownership cost; an analysis interval establishing sampling points for sampling reliability; and/or a confidence level used to increase the statistical confidence or accuracy in the result. The historical reliability is the past reliability of a component, as generally provided by the component manufacturer or supplier. For example, the same component may have been used in other products or systems. Over time, the historical reliability of the component is determined and gathered.

The period or lifecycle over which to determine total ownership cost is generally the warranty period over which the manufacturer is obliged to maintain the product or system. The analysis interval is a predetermined sampling rate or predetermined sampling periods throughout the simulation lifecycle.

The failure statistics for the component may be determined through physical testing or through reliability analysis models, or the like. It should be appreciated that such failure statistics are for the particular component and may include mechanical failure statistics, electrical failure statistics, materials failure statistics, etc. In one embodiment, the failure statistics may be calculated by the analytical modeling procedures 232, such as first order reliability methods or Monte Carlo simulation in the product development engine 200. Monte Carlo simulation is well know in the art. Further examples of Monte Carlo simulation can be found in U.S. Pat. No. 6,226,597 to Eastman et al., and U.S. Pat. No. 6,088,676 to White, Jr., both of which are incorporated herein by reference in their entirety.

The cost data 230(1) is provided per component, and preferably includes: the initial cost and the maintenance cost of the component. The initial cost includes: the purchase cost of the component; the supplier cost of the component; the regional cost of the component; the self-manufacturing cost of the component; the tax cost of the component; etc. The regional cost of the component indicates the different costs of the component throughout different geographical regions. For example, many components are distributed and sold internationally, which affects the cost of a component. Furthermore, different geographical regions within a single country may also influence the cost of the component. Regional costs are also affected by transportation and shipping costs. Also, the tax costs of the component may differ from region to region. The supplier cost is the cost of the component on a supplier-by-supplier basis, as different suppliers generally sell their components for different amounts. For example, companies A, B, and C all supply the thermostat (component 1), but all charge different amounts for their thermostat. Furthermore, manufacturers often have relationships, such as purchase agreements, requirements contracts, or the like, with different supplier companies and may receive discounts that will affect the cost of the component. The self-manufacturing cost is the cost of the component, if the manufacturer makes the component themselves. In some situations, it may be more efficient for a manufacturer to manufacture a component themselves, such as where the manufacturer has experience making a particular component, etc.

The maintenance cost is generally the cost of repairing or replacing the component per failure incident. The maintenance cost often varies per geographic region, thereby generating a regional cost of maintenance. Furthermore, the total maintenance cost is the cumulative maintenance cost over the lifetime of the component's warranty. For example, if the manufacturer supplies a lifetime warranty then the manufacturer may be obliged to repair or replace a faulty component over the entire lifecycle of the product. The maintenance costs may vary depending on the particular component that failed, the hierarchy (described above) between the components, and the interrelationship (described above) between the components. For example, many components that fail can be repaired, however, some components that fail must be replaced because it is either more efficient to replace the component or the component is too expensive or difficult to repair.

Furthermore, the maintenance cost is directly related to the interrelationship between the components (described above). This interrelationship dictates which group of components must be maintained together. Therefore, as in the example above, if the hose (component 2) fails, then the hose clamp (component 5) must also receive maintenance.

The varying nature of component data and maintenance cost data, as described above, generates uncertainty. The uncertainty is described in the form of a statistical function representing the variability of the component and/or maintenance cost. For example, a hose may cost $10 in region A, $12 in region B, and $8 in region C, resulting in a hose mean cost of $10 with a variability of 20%.

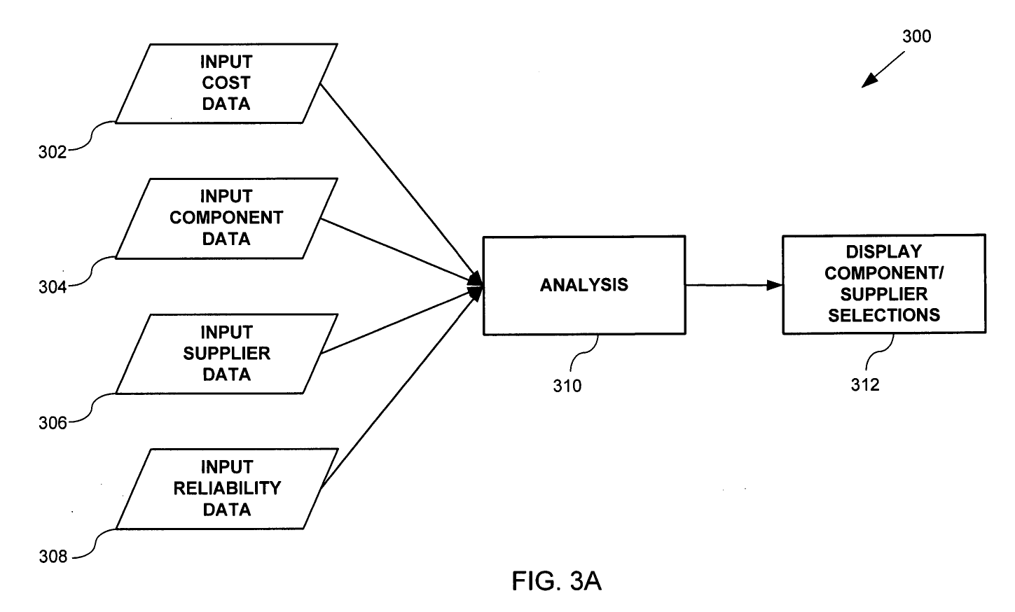

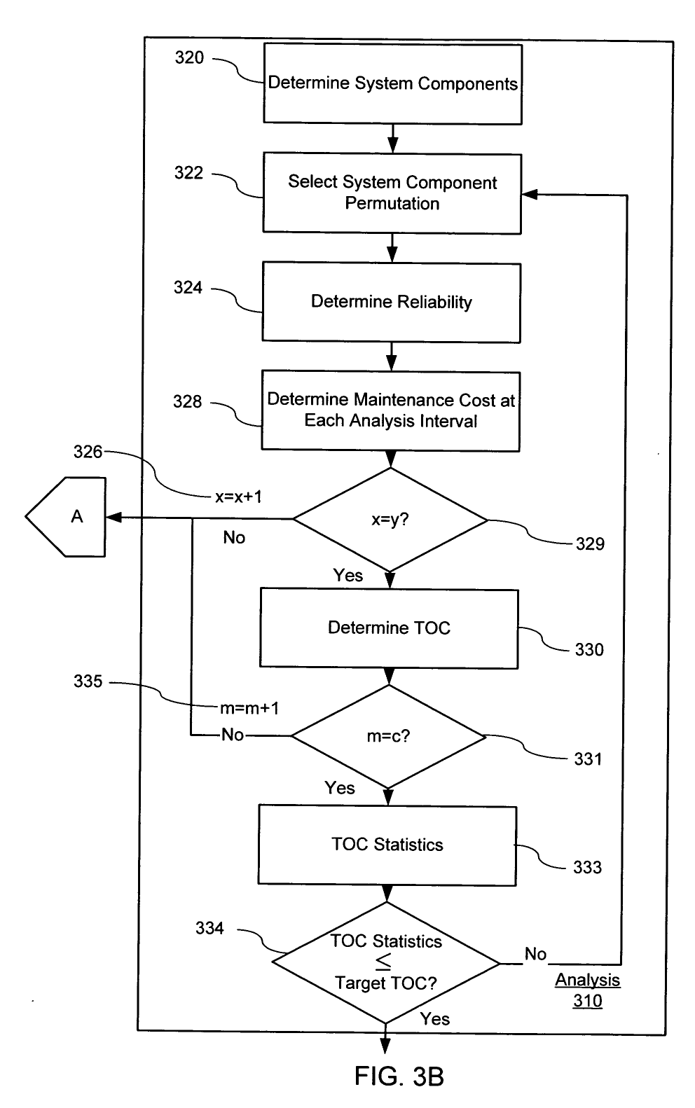

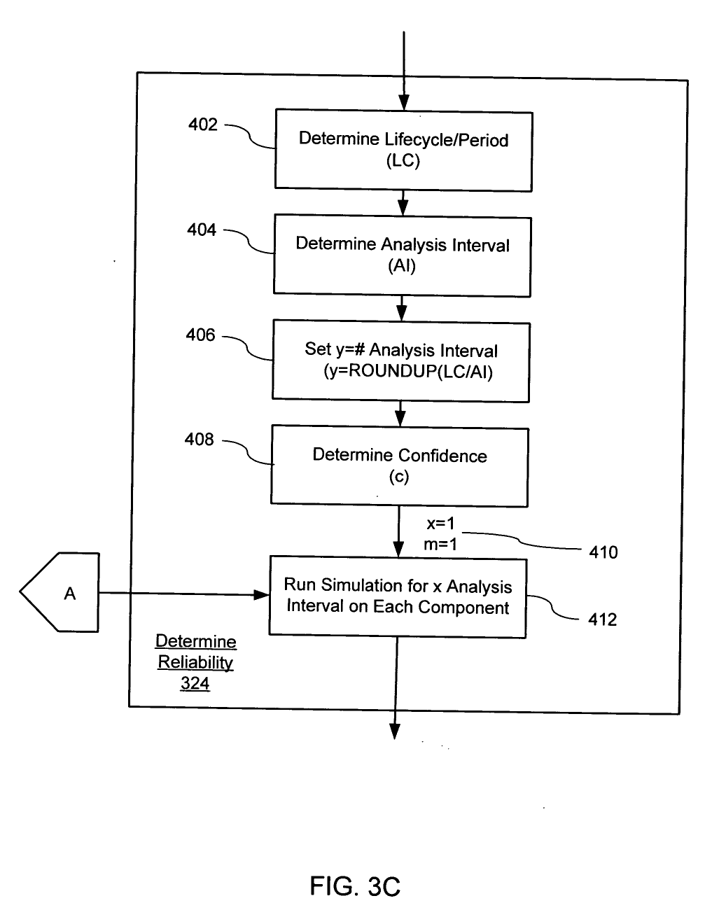

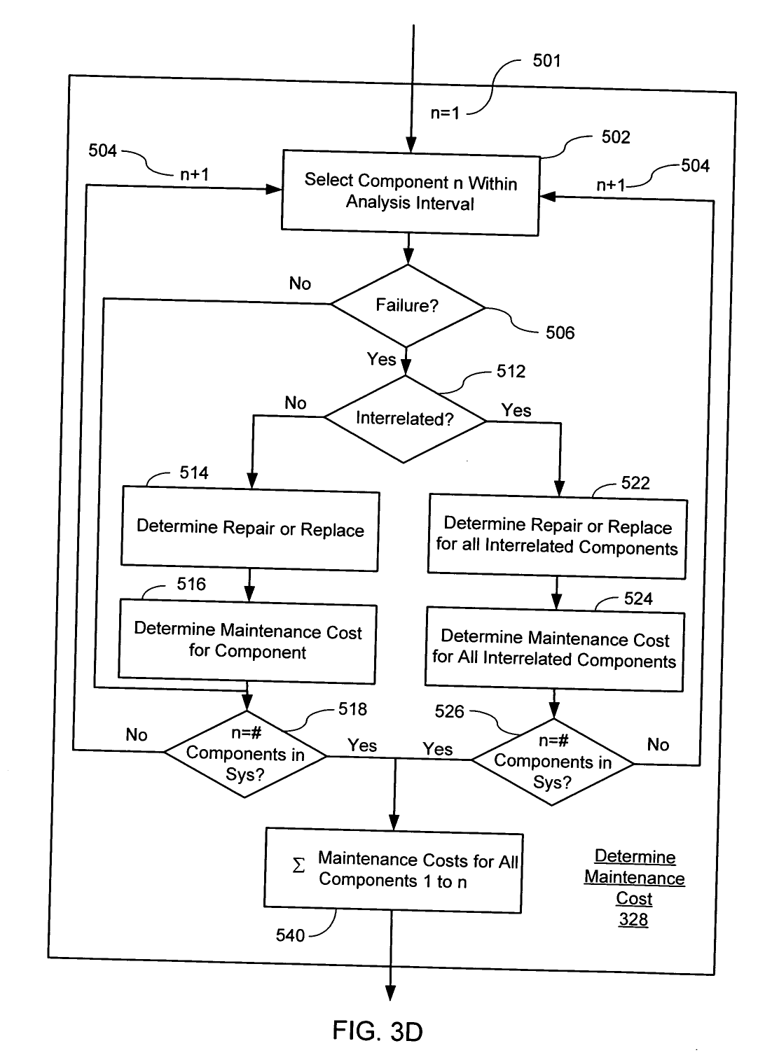

FIG. 3A is a flow chart of the overall method 300 for selecting components or suppliers of components, according to an embodiment of the invention. Initially, various inputs are entered into the product development engine 200 (FIG. 2). These inputs preferably include cost data 230(1) (FIG. 2) at step 302, component data 230(2) (FIG. 2) at step 304, supplier data 230(3) (FIG. 2) at step 306, and reliability data 230(4) (FIG. 2) at step 308. These inputs may be entered via any suitable mechanism, such as via the keyboard and mouse 206 (FIG. 2), loaded from a portable media device like a compact disk, received from a communications network, like the Internet, through the communications interface 210 (FIG. 2), or the like. Analysis is then performed on this data at step 310. This analysis 310 is described in further detail below with reference to FIGS. 3B-3D. The analysis 310 ultimately produces component and/or supplier selections, which are displayed to the user at step 312.

FIG. 3B is a more detailed flow chart of the analysis step 310 of FIG. 3A. Following gathering and entry of the component data, reliability data, supplier data, cost data, and the like, at steps 302-308 (FIG. 3A), the components required to make the system are determined, at step 320. It should be noted that this determination of components is not a determination of the specific components by brand, supplier, manufacturer, or the like that will comprise the product or system, but a general selection of components required by the product or system. For example, consider a system where the designer is designing a new automobile cooling system. The designer may determine that the components desired to produce the cooling system include, as described above; 1) a thermostat, 2) hoses, 3) a radiator cap, 4) a water pump seal, and 5) hose clamps.

The designer then selects an initial permutation scenario of selective components supplied by selective suppliers, at step 322. For example, referring to the above example of an automobile engine cooling system, an initial permutation scenario may be as follows: Company A is selected to supply component 1; component 2 is to be self-manufactured; Company B is selected to supply component 3; and components 3 and 4 are to be supplied by Company C. Alternatively, the product development engine 200 can automatically select an initial permutation scenario, such as by a random selection process or the like.

According to an alternate embodiment, the initial permutation scenario of selecting components can include design parameters of the component, such as component tolerance, reliability, strength, failure rate, cost, base material, and the like.

The reliability of each individual component of the system is subsequently determined at step 324. FIG. 3C, shows a more detailed flowchart of the determining component reliability step of FIG. 3B. The reliability procedures 224 (FIG. 2) determine the lifecycle or period over which to determine the TOC, at step 402. Alternatively, the designer may determine the lifecycle over which to determine TOC in accord with manufacture, intended use, conditions of use, warranty period, and the like. It will be appreciated by one of ordinary skill in the art what an appropriate lifecycle may be depending of the parameters for the specific component or system. This lifecycle or period is the lifecycle of the component that the designer is concerned with, e.g., typically a warranty period. For example, the designer may wish to determine the number of component failures of the automobile cooling system over a lifecycle of 36,000 miles, a typical warranty period for a new automobile.

The designer then determines a sampling rate or analysis interval at step 404. The analysis interval is the predetermined interval at which a sampling of component failure is determined. The final analysis interval is the end point of simulation, or the designated lifecycle for the component, and may or may not fall short of a full analysis interval. For example, the user may wish to sample the automobile cooling system every five thousand miles over the defined lifecycle of 36,000 miles. Therefore, the first analysis interval is at 5,000 miles, the second analysis interval is at 10,000 miles, and so on up to the seventh analysis interval at 35,000 miles. The final analysis interval then occurs just 1,000 miles later at 36,000 miles. The number of analysis intervals, including the end point of the lifecycle is determined and set equal to y, at step 406, i.e., y=ROUNDUP(lifecycle/analysis intervals).

A prediction confidence is then determined for the simulated result, at step 408. The prediction confidence determines how many overall simulations or cycles will be conducted on the system. The prediction confidence is also used to increase the accuracy of the predictions made. The value of prediction confidence is set equal to “c.” For example, a prediction confidence of one will test each component over one predetermined lifecycle, sampling each component at each predetermined analysis interval, whereas a prediction confidence of 1000 will test each component over 1000 predetermined lifecycles, sampling each component at each predetermined analysis interval. Accordingly, the later results will be statistically more accurate. Although higher confidence levels are preferred, the confidence level is chosen based on desired accuracy, competing costs, processing time limitations, and the like. At step 410, x is set to one, i.e., x=1, and m is set to one, i.e. m=1.

Next, component reliability is predicted at step 412. Component reliability is preferably predicted by performing reliability simulations for each component through computational modeling based on reliability failures statistics, physical testing data, historic data, or the like. Such reliability simulations are well known in the art. In a preferred embodiment, the Monte Carlo simulation is used to predict component failure. Monte Carlo simulation is well known in the art and is described in U.S. Pat. No. 6,571,202 to Loman et al. which is incorporated by reference herein in its entirety. Monte Carlo simulations utilize sequences of random numbers to perform simulations. An essential component of a Monte Carlo simulation is the modeling of the physical process by one or more probability density functions (pdf's). By describing the process as a pdf, which may have its origins in physical testing data, historic data, a theoretical model describing the physics of the process, or the like, one can sample an outcome from the pdf at any predetermined analysis interval and acquire a simulation of an actual physical state of the system at that analysis interval.

In a preferred embodiment, the product development engine 200 (FIG. 2) simultaneously simulates component failure for each component in the system, at step 412, up to an analysis interval, where simulation halts, temporarily, for a maintenance cost determination (further described below).

Returning to FIG. 3B, once the reliability has been determined as step 324, the maintenance cost is determined for each component failure at each analysis interval at step 328. For example, considering the automobile cooling system of the above example, assume the following failures occurred during the reliability simulation:

| | | | | | Total |
|---|---|---|---|---|---|
| | Failure by Analysis | | | | Failures |
| | Intervals | | | | per |
| Component | 1st | 2nd | 3^{rd} | Final | Component |
| 1 | | | X | | 1 |
| 2 | | X | | | 1 |
| 3 | X | | X | | 2 |
| 4 | | | | | 0 |
| 5 | X | | | X | 2 |
| Total | 2 | 1 | 2 | 1 | 6 |
| Failures | | | | | |

FIG. 3D is a more detailed flow chart of the maintenance step 328 of FIG. 3B. A counter ‘n’ is initially set to one, i.e., n=1, at step 501. At each analysis interval the costing procedures 226 (FIG. 2) select the n^{th} component of the system for determination of maintenance cost at step 502. At step 506, the reliability procedures 224 (FIG. 2) determine if the n^{th} component failed at this x^{th} analysis interval during reliability testing, step 324 (FIG. 3B). If the component did not fail, (506—No), then the value of n is compared to the total number of components in the system/product, at step 518. If the value of n equals the total number of components in the system (518—Yes), then the method continues at step 540 (described below). If the value of n does not equal, or is less-than, the total number of components in the system/product (518—No), then n is incremented at step 504, and the method begins again with the selection of the next component (n+1) of the system. For example, consider the first analysis interval in the above table. Initially, the first component of the first analysis interval is selected for consideration, at step 502. Next, n is set to one, i.e., n=1, at step 501. It is then determined if component #1 failed, at step 506. In this example, component #1 did not fail at the first analysis interval, so ‘No’ is generated at step 506. Next, the value of n, which here is 1, is compared to the total number of components in this system, which here is 5, i.e., 1≠5, at step 518. Therefore the next component, n+1, is selected for analysis and the method repeats until all components have been analyzed in the first analysis interval.

If a failure is detected (506—Yes), then the reliability procedures 224 (FIG. 2) utilizing component data 230(2) (FIG. 2) determine if the component that failed is interrelated to any other component(s), at step 512. As described above, the interrelationship between components determines if a component that has not failed needs maintenance, regardless of its condition, simply due to its interrelationship with a failed component. For example, considering the automobile cooling system, an interrelationship may exist between components 2 and 5, the hose and hose clamp, respectively. However, due to failure of the hose, the hose clamps associated with the hose must also receive maintenance. An example of the interrelationship between components is shown in the table below with respect to the example of an automobile cooling system.

| Component | Interrelationship |
|---|---|
| 1 | |
| 2 | 5 |
| 3 | |
| 4 | 2, 5 |
| 5 | 2 |

As shown in the table, component 2 is interrelated to component 5 such that if component 2 fails, component 5 must also receive maintenance. Furthermore, as shown, component 4 is interrelated to components 2 and 5, such that if component 4 fails both components 2 and 5 must receive maintenance. If component is not related to any other component, (512—No), the costing procedures 226 (FIG. 2) determine if the component should be repaired or replaced from the repair/replace flag at step 514.

Next, the maintenance cost is determined for the failed component, at step 516, by looking up the cost data 230(1) (FIG. 2) with respect to the particular component in question. Following a determination of the maintenance cost, the value of n is compared to the total number of components of the system, at step 518. If the value of n equals the total number of components in the system, (518—Yes), then the method continues at step 540 (described below). However, if the value of n is less-than the total number of components in the system, (518—No), then the next component (n+1) is selected at step 502, n is incremented at step 504, and the method repeats. For example, considering the automobile cooling system and the scenario in the tables above, in the first analysis interval a failure is detected, at step 506, for component # 3. At step 512, no interrelationship exists for component # 3, (512—No), as shown in the component interrelationship table above. Next, the method determines if the component # 3 should be repaired or replaced, at step 514. The associated maintenance cost of component # 3 is then determined, at step 516. The value of n, or 3 in this example, is then compared with the total number of components in the system, or 5 in this example, i.e., 3≠5, (518—No is generated), then n is incremented, i.e. 3+1=4, at 504, and the next component is selected at step 502, and the method repeats.

If an interrelationship is determined between components, (512—Yes), then the costing procedures 226 (FIG. 2) determine whether each component that is interrelated to the failed component should be repaired or replaced at step 522. Next, the method determines the maintenance cost associated with the failed component and all interrelated components, at step 524, by referring to the cost, component, and supplier data 230(1)-230(3) (FIG. 2). At step 526, the value of n is compared to the total number of components of the system. If the value of n equals the total number of components in the system, (526—Yes), then the method continues at step 540 (further described below). However, if the value of n is less-than the total number of components in the system, (526—No), then n is incremented, i.e. n+1, and the next component is selected at step 502. For example, consider the first analysis interval and component # 5 of the automobile cooling system of the tables above. A failure is determined for component # 5 in the first analysis interval, (506—Yes). Furthermore, an interrelationship is determined for component # 5, (512—Yes), and the related component, cost 230(1), and supplier data 230(3) dictates that a failure of component # 5 requires that component # 2 also be repaired or replaced. At step 522, the costing procedures 226 (FIG. 2) determines, if the failed component, component # 5, and all interrelated components, component # 2 in this example, can be repaired or must be replaced. Step 524 determines the maintenance cost associated with the maintenance determined at step 522 by looking up the cost data 230(1) and the component data 230(2) for the failed and interrelated components. Next, at step 526, the value of n, 5 in this example, is compared to the total number of components in the system, also 5 in this example, i.e., 5=5, (526—Yes). Therefore, the method progresses to step 540 (further described below).

When all the components of the system have been analyzed in a given analysis interval, i.e., n=total number components of the system, (518—Yes, or 526—Yes) then the maintenance costs for all of the failed components and any interrelated components are summed, at step 540.

Returning to FIG. 3B, following the determination of the maintenance cost of the system for an analysis interval at step 328, the value of x (counter) is compared to y (the total number of predetermined analysis intervals over the predetermined lifecycle) at step 329. If the value of x (counter) does not equal the value of y (# of analysis intervals), i.e., x ≠y (329—No), then x is incremented and the method returns to step 412 (FIG. 3C) and continues to simulate component reliability until all analysis intervals have been simulated. If the value of x equals the value of y, i.e., x=y (329—Yes), then the TOC is determined, at step 330. TOC is determined by summing the system maintenance cost determined at each analysis interval and adding it to the sum of the initial cost for all components in the system. Next, the value of m (the number of cycles through the reliability simulation) is compared to the value of c (the number of cycles required by the confidence interval) i.e., m=c?, at step 331. If the value of m does not equal c, i.e., m≠c, m is incremented, i.e., m+1, at step 335 and the method returns and runs through another simulation of the system components at step 412 (FIG. 3C). If, however, the value of m equals the value of c, i.e., m=c, at step 331, then the average or median TOC is determined at step 333. It should be appreciated that TOC can be an average of each TOC value acquired for each simulation in the confidence interval, TOC can be the median TOC value, TOC can be another statistical moment, or the like, which are collectively referred to as TOC statistics. Furthermore, after each component failure is analyzed and its associated maintenance cost is determined (further described below) the method continues with simulation a maintained component i.e., new or replaced component, and any interrelated components.

Next, the TOC statistics are compared to a target TOC, at step 334. If the TOC is less-than or equal to the target TOC, (334—Yes), the method displays at step 312 (FIG. 3A). However, if the TOC is not less than or equal to the target TOC, (334—No), the method returns to step 322 and selects a new permutation of components from different suppliers and the method repeats itself until a suitable list of components and/or suppliers is found. It should, however, be appreciated that if the target TOC is too low, a suitable list of components and/or suppliers may never be found. In this situation, the method may prompt the user to enter a new target TOC or new suppliers after a predetermined number of loops (not shown).

According to an embodiment of the invention, an option for acquiring a component at an initial cost sufficient to minimize a TOC to within target cost range is for a manufacturer to self-manufacture, or for a supplier to re-design a component.

According to an alternative embodiment, simulation of component failure can run to a completion over the predetermined lifecycle, without pausing to calculate maintenance cost at each analysis interval. In the embodiment, after completion of failure simulation the component failures that occurred during simulation are summed for each component along with any interrelated components requiring repair or replacement maintenance. Next, the number components requiring maintenance are multiplied by the initial cost of that component generating a total cost per component over the predetermined lifecycle. Thereafter, the total lifecycle cost per component is summed, generating a system total cost.

In an alternate embodiment, the step of selecting system component permutations 322 (FIG. 3B) includes altering the design parameters of a component such that component design trade-offs that lead to optimal function, reliability, and cost can be factored into the total ownership cost analysis prediction. It will be appreciated by one of ordinary skill in the art that parameters of a self-manufactured component, such as base material, fracture strength, material quality, defect, and tolerance considerations, or the like, can be automatically adjusted at step 322 to satisfy a target TOC. An example of selecting or adjusting such design or manufacturing parameters is outlined below.

For example, consider a self-manufactured hose made of a polymer material. Typically, polymer materials can be found to include inherent foreign inclusions or defects. During manufacture of the polymer hose, depending on manufacture control procedures, the defects that occur during manufacture can be controlled to some degree, thereby resulting in hoses of different quality levels. However, as manufacturing controls increase, so too does the cost of manufacturing the component. Therefore, the failure mechanism of the heater hose is modeled using analytical modeling techniques, by the analytical modeling procedures 232 (FIG. 2), which allows for probability of failure estimation.

Typical self-manufacturing of a component begins with defining a concept design that includes parameters of materials to be utilized in making the component. Such parameters include material attributes such as fracture strength. A fracture strength for the polymer material of the hose in this example can be 8.5 in-lb/in². Further included are component attributes, such as establishing conditions which the hose must withstand. In the above example, assume the polymer hose must withstand a stress of 30,890 psi with a probability of failure of less-than 0.01. Manufacturing attributes can also be included and include such parameters as defect size. Assume the defect size of the above hose cannot exceed 0.005 in. (inches). Furthermore, tolerance restrictions may also be established for the end component. Consider the hose must have a tolerance on strength of between 0.5-2.5 in-lb/in², and a tolerance on defect size of between 0.0005-0.0015 in.

Next, the design requirements are determined. For illustration purposes, assume the acceptable range for the hose of the above example, according to nominal strength and defect size are 4-9 in-lb/in² and 0.001-0.01 in, respectively.

Cost sensitivity values must be obtained that correlate to the specific material attributes chosen. It will be appreciated by one of skill in the art that cost values can be obtained from manufacturing engineering, however, if such values are not available, mean cost values may be employed along with the cost difference of different tolerances and the cost of inspection of the component. Once the values are obtained they are tabulated as follows:

Cost of Mean

| Mean Value (Nominal) | Cost |
|---|---|
| μ₁ | C₁ |
| μ₂ | C₂ |
| μ₃ | C₃ |

From the above table the cost sensitivity to the mean (∂Cost/∂μ) can be determined, as can be determined for the other sensitivities.

Performance metrics for the component to be developed are determined by considering the physics of failure of the material to be employed, according to techniques known in the art. For example, a failure equation, according to the hose example above was developed. The equation relates the strength, defect size, and applied stress to the probability of failure of the hose. The failure equation is:

0=G_{crit}−(−2.37505+3.48′ 10⁻⁵s−2.5′ 10⁻¹⁰s²+355.69a−3306.07a²+3.84′ 10⁻⁴sa)

where G_{crit} is the material fracture strength, a is the defect size and s is the applied stress.

Based on the initial inputs of the design parameter values, the equation failure probability of the heater hose is determined to be 0.0152. This value exceeds the mandated value of 0.01 set for the component, therefore, the design of the component must be modified to satisfy the probability of failure while keeping the cost under control.

Cost sensitivities can be established based on data obtained from manufacturers. The cost sensitivities are typically normalized, thus representing the cost of changing the design variable distribution parameters in one unit increments. Therefore, the cost to shift the nominal value is represented by ∂Cost/∂μ. Whereas the cost to change the standard deviation (manufacturing tolerance) is represented by ∂Cost/∂μ. Negative values of sensitivities indicate that a reduction in the parameter requires an increase in cost as shown in the table below.

| Variable | ∂Cost/∂μ | ∂Cost/∂σ |
|---|---|---|
| Strength | 80 | −100 |
| Defect Size | −20,000 | −30,000 |

An objective of optimization can be to minimize the relative cost of the component by allowing each of the design parameters to change, however, while satisfying design requirements. The design constraints ensure that the required probability of failure criteria is met and the design parameters are held within the allowable ranges. An optimization problem is then solved to produce the final recommendation of design parameter values for the component.

With respect to the above example of the hose, an optimization problem can be as follows:

Minimize Cost: −20000Δμₐ+80Δμ_{G}−30000Δσₐ−100Δσ_{G} (2)

where, the optimization problem is subject to the following design constraints:

0.0152−0.01≦10.24918Δμₐ−0.0307Δμ_{G}+6.45698Δσₐ+0.063236Δσ_{G}

0.001≦μₐ≦0.01 0.0005≦σₐ≦0.0015

4≦μ_{G}≦9 0.5≦σ_{G}≦2.5

| Parameter | Initial Value | Optimized Value | Cost Impact |
|---|---|---|---|
| POF | 0.0152 | 0.0097 | |
| Mean Defect size | 0.005 in | 0.00102 in | 79.6 |
| Mean Strength | 8.5 in-lb/in² | 4.361 in-lb/in² | −331.12 |
| Tol-Defect size | 0.001 in | 0.00138 in | −11.4 |
| Tol-Strength | 2.0 in-lb/in² | 0.504 in-lb/in² | 149.6 |
| | | Total | −113.32 |

Therefore, design optimization that considers reliability and cost produce a final design configuration saved 113.32 cost units over the original configuration, while still satisfying probability of failure (POF) requirements.

Next, the product development engine 200 takes into consideration the fact that predicted total cost of the self-manufactured component is reduced by $113.32. Returning now to FIG. 3B, the TOC, reflecting the self-manufactured option is compared to the target cost, at step 335. As described above, if TOC is less-than or equal to the target, (335—Yes) then the system is displayed with the preferable options for supplier and self-manufacture per component. However, if the TOC is greater than target cost (335—No), then a further refinement of the design and/or manufacturing process may be undertaken. In accordance with this embodiment, the analytical modeling procedures 232 (FIG. 2) can alter the tolerance, material quality, number allowable defects, material strength parameters, and the like, and re-run the analysis to determine a permutation scenario that satisfies the target cost.

According to an alternate embodiment, the display component selections 312 (FIG. 3A) can display the first permutation of components that meet target costs 335 (FIG. 3B). According to another embodiment, the product development engine 200 can analyze all possible permutations for the component and supplier data available and display the permutation which produces the lowest TOC. In yet another embodiment, the product development engine 200 can analyze all or any portion of the permutations possible for the component and supplier data available and display the TOC for each permutation, such that the designer can choose accordingly.

The foregoing descriptions of specific embodiments of the present invention are presented for purposes of illustration and description. For example, any methods described herein are merely examples intended to illustrate one way of performing the invention. They are not intended to be exhaustive or to limit the invention to the precise forms disclosed. Obviously many modifications and variations are possible in view of the above teachings. Also, any graphs described herein are not drawn to scale. The embodiments were chosen and described in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents.

What we claim is:

1. A method for determining a total ownership cost of a system, comprising:
receiving data for each component of a system, including an initial cost of each component, a maintenance cost of each component, and a period over which to determine a total ownership cost of said system;
predicting failure of each component over said period;
determining a total ownership cost of the system by summing each component's initial cost and the maintenance cost of each failed component.

2. The method of claim 1, further comprising, before said determining, ascertaining whether each failed component should be repaired or replaced.

3. The method of claim 1, further comprising, before said determining, ascertaining whether any component related to a failed component should be maintained together with said failed component.

4. The method of claim 1, wherein said receiving further comprises receiving an analysis interval used for said predicting.

5. The method of claim 1, wherein said receiving further comprises receiving a list of suppliers for each component and each supplier's associated initial cost for each component.

6. The method of claim 5, further comprising, before said predicting, choosing a supplier and associated initial cost, for each component.

7. The method of claim 6, further comprising:
selecting a different supplier and associated different initial cost, for each component; and
repeating said predicting and said determining for said different initial cost.

8. The method of claim 1, wherein before said predicting, altering design parameters for at least one component and repeating said predicting and said determining.

9. The method of claim 1, wherein said receiving further comprises receiving failure statistics for each component, where said failure statistics are used for said predicting.

10. The method of claim 1, wherein said receiving further comprises receiving reliability data for each component, where reliability data is used for said predicting.

11. The method of claim 1, further comprising, displaying said total ownership cost.

12. The method of claim 1, wherein said predicting comprises invoking a reliability prediction.

13. The method of claim 1, further comprising after said determining comparing said determined total ownership cost to a target ownership cost of the system.

14. The method of claim 13, further comprising repeating receiving data for at least one different component of the system if said determined total ownership cost of the system is greater than said target ownership cost of the system.

15. An apparatus for determining total ownership cost of a system, comprising:
a central processing unit;
a communication interface; and
a memory comprising;
an operating system;
communication procedures for receiving data for each component of a system, including an initial cost of each component, a maintenance cost of each component, and a period over which to determine a total ownership cost, and for communicating a result through said communication interface;
reliability procedures for predicting failure of each component over said period; and
costing procedures for determining a total ownership cost of the system by summing each component's initial cost and the maintenance cost of each failed component.

16. The apparatus of claim 15, wherein said memory further comprises procedures for ascertaining whether each failed component should be repaired or replaced.

17. The apparatus of claim 15, wherein said memory further comprises procedures for ascertaining whether any component related to a failed component should be maintained together with said failed component.

18. The apparatus of claim 15, wherein said communication procedures for receiving further comprise receiving an analysis interval used for said predicting.

19. The apparatus of claim 15, wherein said communication procedures for receiving further comprise receiving a list of suppliers for each component and each supplier's associated initial cost for each component.

20. The apparatus of claim 19, wherein said memory further comprises procedures for, before said predicting, choosing a supplier and associated initial cost, for each component.

21. The apparatus of claim 20, wherein said memory further comprises procedures for:
selecting a different supplier and associated different initial cost, for each component; and
repeating said predicting and said determining for said different initial cost.

22. The apparatus of claim 15, wherein said memory further comprises, displaying said total ownership cost.

23. The apparatus of claim 15, wherein said reliability procedures for said predicting comprises invoking a reliability prediction.

24. The apparatus of claim 15, wherein said memory further comprises procedures for comparing said determined total ownership cost to a target ownership cost of the system.

25. The apparatus of claim 24, wherein said memory further comprises procedures for repeating receiving data for at least one different component of the system if said determined total ownership cost of the system is greater than said target ownership cost of the system.

26. The apparatus of claim 15, wherein said memory further comprises procedures for changing manufacturing parameters of at least one component and repeating said determining total ownership cost.

27. A method for determining a total ownership cost of a system, comprising:
receiving data for each component of a system, including an initial cost of each component, a maintenance cost of each component, and a period over which to determine a total ownership cost of said system;
choosing a supplier and associated initial cost for each component;
predicting failure of each component over said period;
ascertaining whether each failed component should be repaired or replaced;
ascertaining whether any component related to the failed component should be repaired or replaced;
determining a total ownership cost of the system by summing each component's initial cost and the maintenance cost of each failed component;
comparing said determined total ownership cost of the system to a target total ownership cost of the system; and
selecting a different supplier and associated initial cost for each component and repeating said determining for said different supplier if said total ownership cost is greater-than said target total ownership cost.
